(19) United States
(12) Patent Application Publication
(10) Pub. No.: US 2026/0221371 A1
(43) Pub. Date: Jul. 30, 2026

(54) ION SOURCE CATHODE WITH MONOLITHIC RADIATION SHIELDS

(71) Applicant: Axcelis Technologies, Inc., Beverly, MA (US)

(72) Inventors: Joshua Abeshaus, Haverhill, MA (US); David Shaner, Topsfield, MA (US); Makita Erni, Peabody, MA (US); Alireza Pirnia, Reading, MA (US); Olivia Campbell, Beverly, MA (US); Neil Bassom, Hamilton, MA (US)

(21) Appl. No.: 19/456,368

(22) Filed: Jan. 22, 2026

Related U.S. Application Data
(60) Provisional application No. 63/749,209, filed on Jan. 24, 2025.

(51) Int. Cl. H01J 1/26; H01J 1/24; H01J 9/04

(52) U.S. Cl. CPC H01J 1/26; H01J 1/24; H01J 9/04

(57) ABSTRACT

An indirectly heated cathode for an ion source has a filament and a monolithic cathode body. The monolithic cathode body extends along an axis from first to second ends, consists of a solid rod, a tubular portion, and one or more thermal shields. The solid rod defines an end cap and extending from the first end toward the second end. The tubular portion is contiguous with the solid rod and defines a cavity extending from the second end toward the first end to a closed end wall. A filament is positioned within the cavity. A thermal shield is contiguous with the tubular portion and/or the solid rod to limit a transfer of thermal radiation from the filament to one or more regions external to the monolithic cathode body. The thermal shields can be disk or an annular shield. The filament is closer to the closed end wall than the disk.

### REFERENCE TO RELATED APPLICATIONS

This application claims the benefit of U.S. Provisional Application Serial No. 63/749,209 filed January 24, 2025, entitled, “CATHODE WITH INTEGRATED RADIATION SHIELDS”, the contents of all of which are herein incorporated by reference in their entirety.

### TECHNICAL FIELD

The present invention relates generally to ion implantation systems, and more specifically to an improved ion source and cathode that improve a lifetime, stability, and operation of various aspects of an ion implantation system.

### BACKGROUND

In the manufacture of semiconductor devices, ion implantation is used to dope semiconductors with impurities. Ion implantation systems are often utilized to dope a workpiece, such as a semiconductor wafer, with ions from an ion beam in order to either produce n- or p-type material doping, or to form passivation layers during fabrication of an integrated circuit. Such beam treatment is often used to selectively implant the wafers with impurities of a specified dopant material, at a predetermined energy level, and in controlled concentration, to produce a semiconductor material during fabrication of an integrated circuit. When used for doping semiconductor wafers, the ion implantation system injects a selected ion species into the workpiece to produce the desired extrinsic material. Implanting ions generated from source materials such as antimony, arsenic, or phosphorus, for example, results in an “n-type” extrinsic material wafer, whereas a “p-type” extrinsic material wafer often results from ions generated with source materials such as boron, gallium, or indium.

A typical ion implanter includes an ion source, an ion extraction device, a mass analysis device, a beam transport device and a wafer processing device. The ion source generates ions of desired atomic or molecular dopant species. These ions are extracted from the source by an extraction system, typically a set of electrodes, which energize and direct the flow of ions from the source, forming an ion beam. Desired ions are separated from the ion beam in a mass analysis device, typically a magnetic dipole performing mass dispersion or separation of the extracted ion beam. The beam transport device, typically a vacuum system containing a series of focusing devices, transports the ion beam to the wafer processing device while maintaining desired properties of the ion beam. Finally, semiconductor wafers are transferred in to and out of the wafer processing device via a wafer handling system, which may include one or more robotic arms, for placing a wafer to be treated in front of the ion beam and removing treated wafers from the ion implanter.

Ion sources (commonly referred to as arc discharge ion sources) generate ion beams used in implanters and can include heated filament cathodes for creating ions that are shaped into an appropriate ion beam for wafer treatment. U.S. Pat. No. 5,497,006 to Sferlazzo et al., for example, discloses an ion source having a cathode supported by a base and positioned with respect to a gas confinement chamber for ejecting ionizing electrons into the gas confinement chamber. The cathode of the Sferlazzo et al. patent is a tubular conductive body having an endcap that partially extends into the gas confinement chamber.

### SUMMARY

The present disclosure thus provides a system and apparatus for increasing the efficiency and lifetime of an ion source. Accordingly, the following presents a simplified summary of the disclosure in order to provide a basic understanding of some aspects of the invention. This summary is not an extensive overview of the invention. It is intended to neither identify key or critical elements of the invention nor delineate the scope of the invention. Its purpose is to present some concepts of the invention in a simplified form as a prelude to the more detailed description that is presented later.

In accordance with one aspect of the disclosure, an indirectly heated cathode for an ion source is provided, whereby the indirectly heated cathode comprises a filament and a monolithic cathode body. The monolithic cathode body extends along an axis from a first end to a second end thereof, and comprises a solid rod defining an end cap and extending from the first end toward the second end. The monolithic cathode body further comprises a tubular portion, wherein the tubular portion is contiguous with the solid rod and defines a cavity extending from the second end toward the first end to a closed end wall of the cavity. The filament, for example, is positioned within the cavity. The monolithic cathode body further comprises one or more thermal shields. The one or more thermal shields, for example, are contiguous with one or more of the tubular portion and the solid rod, wherein the one or more thermal shields are configured to limit a transfer of thermal radiation from the filament to one or more regions external to the monolithic cathode body.

In accordance with one example, the one or more thermal shields comprise at least one disk disposed within the cavity. The filament, for example, is disposed between the at least one disk and the closed end wall of the cavity, wherein the filament is positioned at a first predetermined distance from the closed end wall and at a second predetermined distance from the at least one disk. The second predetermined distance is greater than the first predetermined distance, such as being approximately twice the first predetermined distance.

The at least one disk, for example, may comprise a plurality of disks axially spaced along the axis and having a predetermined spacing therebetween, wherein the filament is positioned at the second predetermined distance from an innermost disk of the plurality of disks. The filament, for example, may comprise one or more support leads electrically coupled to the filament, wherein the at least one disk comprises one or more apertures, and wherein the one or more support leads extend through the one or more apertures, respectively.

The one or more thermal shields may further or alternatively comprise an annular shield axially encircling and contiguous with at least the tubular portion of the monolithic cathode body, wherein the annular shield is spaced an annular shield distance from an external circumference of the tubular portion.

The tubular portion, for example, may define a tubular portion outer diameter, whereby the solid rod defines a solid rod outer diameter, and wherein the solid rod outer diameter decreases from the tubular portion outer diameter in a stepped region of the solid rod.

The one or more thermal shields, for example, may further or alternatively comprise one or more stepped shields axially encircling the solid rod in the stepped region thereof, whereby the one or more stepped shields are contiguous with the solid rod proximate to the closed end wall. The one or more stepped shields, for example, may be spaced a respective stepped shield distance from a stepped region circumference of the stepped region of the solid rod. The one or more stepped shields, for example, may define a respective stepped shield outer diameter, wherein at least one stepped shield diameter respectively increases from the first end toward the second end.

In accordance with another example, an indirectly heated cathode for an ion source is provided, whereby a filament defines a filament plane having an axis perpendicular thereto. A monolithic cathode body, for example, extends along the axis from a closed end to an open end of the monolithic cathode body. The monolithic cathode body, for example, comprises a solid rod extending from the closed end toward the open end and a tubular portion defining a cavity extending from the open end toward the solid rod. The tubular portion, for example, is continuous with the solid rod, whereby the solid rod defines a closed end wall of the cavity. The filament plane of the filament, for example, is spaced a first predetermined distance from the closed end wall.

Further, the monolithic cathode body comprises one or more thermal shields configured to limit a transfer of thermal radiation from the filament to one or more regions external to the monolithic cathode body. The one or more thermal shields, for example, comprise at least one disk disposed within the cavity, wherein the filament is disposed between the at least one disk and the closed end wall. At least one disk, for example, is axially spaced a second predetermined distance from the filament plane of the filament, wherein the second predetermined distance is greater than the first predetermined distance.

In one example, the second predetermined distance is greater than approximately twice the first predetermined distance. In another example, the at least one disk comprises a plurality of disks axially spaced along the axis and having a predetermined spacing therebetween, wherein the filament is positioned at the second predetermined distance from an innermost disk of the plurality of disks. In yet another example, the at least one disk comprises a body having one or more convolutions or angled surfaces defined therein. Further, the tubular portion may comprises a thin sidewall, wherein the at least one disk is integrally connected to the thin sidewall, and wherein the thin sidewall is configured to be coupled to a cathode holder.

In yet another example, the indirectly heated cathode may further comprise a cathode shield. The one or more thermal shields, for example, may comprise an annular shield axially encircling and contiguous with at least the tubular portion and spaced from an external circumferential surface of the monolithic cathode body, wherein the one or more thermal shields further comprise one or more stepped shields axially encircling the solid rod in a stepped region thereof, and wherein the cathode shield axially encircles the annular shield and the one or more stepped shields.

According to another example of the disclosure, a method for forming an indirectly heated cathode is provided, whereby a tubular member is formed, wherein the tubular member comprises an annular sidewall defining an open end of a monolithic cathode body. In one example, at least one disk is formed, wherein the at least one disk comprises one or more apertures defined therethrough. The at least one disk is integrally coupled to an internal surface of the annular sidewall, and one or more filament support leads having a filament coupled thereto are inserted through the one or more apertures. A solid rod having a closed end wall is further formed, whereby the closed end wall is further integrally coupled to the tubular portion to define a cavity between within the annular sidewall, the closed end wall of the solid rod, and the open end of the tubular member. The tubular member, the at least one disk, and the solid rod define the monolithic cathode body, whereby the filament is positioned between the at least one disk and the closed end wall of the solid rod within the cavity, and whereby the one or more support leads extend out of the cavity from the open end of the monolithic cathode body.

The tubular member, the at least one disk, and the solid rod, for example, may be formed via an additive manufacturing process, e-beam welding, or other process, whereby the monolithic cathode body is formed of a continuous material.

To the accomplishment of the foregoing and related ends, the disclosure comprises the features hereinafter fully described and particularly pointed out in the claims. The following description and the annexed drawings set forth in detail certain illustrative embodiments of the invention. These embodiments are indicative, however, of a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

FIG. 1 illustrates a cross-sectional view of a conventional ion source having a conventional indirectly heated cathode.

FIG. 2 is a block diagram of a system utilizing an ion source in accordance with several aspects of the present disclosure.

FIGS. 3 is a cross-sectional view of an example ion source in accordance with several aspects of the present disclosure.

FIGS. 4A-4B are respective perspective cross-sectional and a cross-sectional views of a monolithic cathode body having one or more radiation shields with at least one disk in accordance with several aspects of the present disclosure.

FIGS. 5A-5B are respective perspective cross-sectional and a cross-sectional views of a monolithic cathode body having one or more radiation shields with at least one annular shield in accordance with several aspects of the present disclosure.

FIGS. 6A-6B are respective perspective cross-sectional and a cross-sectional views of a monolithic cathode body having one or more radiation shields with one or more stepped shields in accordance with several aspects of the present disclosure.

FIGS. 7A-7B are respective perspective cross-sectional and a cross-sectional views of a monolithic cathode body having one or more radiation shields with at least one disk, at least one annular shield, and one or more stepped shields in accordance with several aspects of the present disclosure.

FIGS. 8A-8D are a series of perspective cross-sectional views of an indirectly heated cathode while performing a method of forming the indirectly heated cathode in accordance with several aspects of the present disclosure.

FIG. 9 is a block diagram illustrating a method of forming an indirectly heated cathode in accordance with several aspects of the present disclosure.

### DETAILED DESCRIPTION

The present disclosure is directed generally toward a cathode apparatus for an ion source and methods for forming same, whereby the cathode apparatus may be provided in the ion source of an ion implantation system for forming an ion beam. More particularly, the present disclosure provides an indirectly heated cathode (IHC) for an ion source, whereby the indirectly heated cathode comprises a filament disposed within a cavity of a monolithic cathode body. The monolithic cathode body comprises one or more thermal shields integrated therein, whereby the one or more thermal shields are configured to limit thermal power losses associated with the indirectly heated cathode. Thus, in accordance with various examples of the present disclosure, one or more of an increase in a lifetime of the ion source and an improvement of power efficiency of the ion source is hereby provided.

Accordingly, the present invention will now be described with reference to the drawings, wherein like reference numerals may be used to refer to like elements throughout. It is to be understood that the description of these aspects are merely illustrative and that they should not be interpreted in a limiting sense. In the following description, for purposes of explanation, numerous specific details are set forth in order to provide a thorough understanding of the present invention. It will be evident to one skilled in the art, however, that the present invention may be practiced without these specific details. Further, the scope of the invention is not intended to be limited by the embodiments or examples described hereinafter with reference to the accompanying drawings, but is intended to be only limited by the appended claims and equivalents thereof.

It is also noted that the drawings are provided to give an illustration of some aspects of embodiments of the present disclosure and therefore are to be regarded as schematic only. In particular, the elements shown in the drawings are not necessarily to scale with each other, and the placement of various elements in the drawings is chosen to provide a clear understanding of the respective embodiment and is not to be construed as necessarily being a representation of the actual relative locations of the various components in implementations according to an embodiment of the invention. Furthermore, the features of the various embodiments and examples described herein may be combined with each other unless specifically noted otherwise.

It is also to be understood that in the following description, any direct connection or coupling between functional blocks, devices, components, elements or other physical or functional units shown in the drawings or described herein could also be implemented by an indirect connection or coupling. Furthermore, it is to be appreciated that functional blocks or units shown in the drawings may be implemented as separate features in one embodiment, and may also or alternatively be fully or partially implemented in a common feature in another embodiment.

Ion implantation is a process that is employed in semiconductor device fabrication in which ions of one or more elements are accelerated into a workpiece in order to change the properties of the workpiece. For example, it is common for dopants such as boron, arsenic, and phosphorus to be implanted into silicon to modify its electrical properties. In an exemplary ion implantation process, an element or molecule of interest is ionized, extracted, and accelerated electrostatically to form a high energy ion beam, filtered by its mass-to-charge ratio, and directed to strike a workpiece. The ions physically bombard the wafer, enter the surface and come to rest below the surface, at a depth related to their energy.

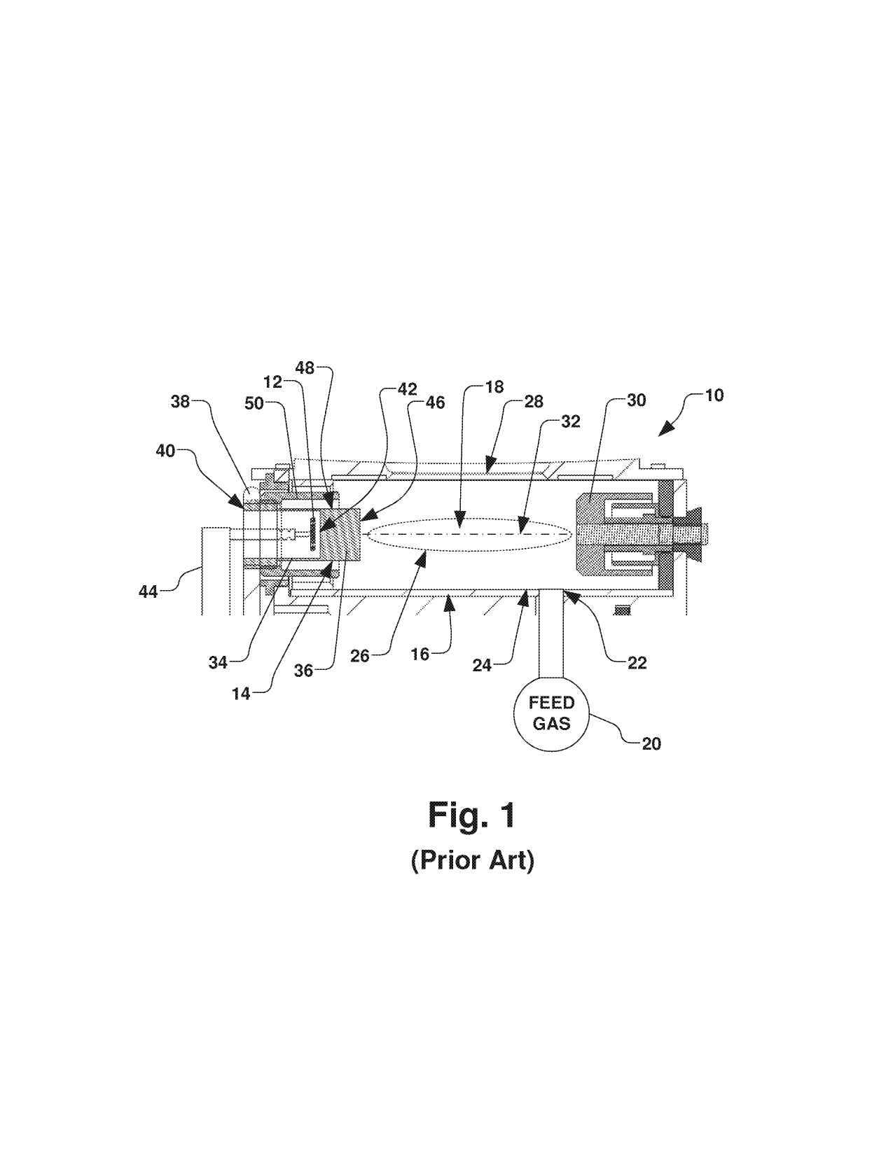

In order to gain a better understanding of the present disclosure, FIG. 1 illustrates a cross section of an ion source 10 that may be used in a conventional ion implantation system. A filament 12 is resistively heated to a temperature at which thermionic emission of electrons occurs. A voltage (a so-called “cathode voltage”) between the filament 12 and a cathode 14 accelerates the emitted electrons from the filament toward the cathode until the cathode, itself, thermally emits electrons. Such an emission scheme is termed in the industry as an indirectly heated cathode (IHC). The cathode 14, for example, serves two purposes; namely, the cathode protects the filament 12 from being bombarded by plasma ions, and it provides electrons for subsequent ionization.

The cathode 14 is biased negatively with respect to an arc chamber 16 in which it resides as a so-called “arc voltage”, and the emitted electrons are accelerated toward a center 18 of the arc chamber. A feed gas 20 is flowed into the arc chamber 16 through a feed gas inlet 22 in a sidewall 24 of the arc chamber, and the emitted electrons subsequently ionize the feed gas, thus forming a plasma 26 from which ions can be extracted via an extraction slit 28 in the arc chamber. A repeller 30, for example, is typically at or near the same potential of the cathode 14 and repels electrons back into the plasma, thus leading to enhanced ionization and a denser plasma. A magnetic field (not shown) that is parallel to a center axis 32 defined by the cathode 14 and repeller 30 generally confines the emitted and repelled electrons to define a so-called “plasma column”, thus improving ionization and plasma density even further.

In general, the cathode 14, itself, fails due to sputtering and erosion by plasma ions, and eventual permeation or punch-through of the cathode. This is especially true when tuning for multi-charge ion beams, which leads to significantly shorter lifetimes of the ion source when compared to singly-charged ions.

The cathode 14 consists of a thin-walled cylinder 34 (typically having a wall thickness of less than 1mm) and an end cap 36 (typically having a length of 5-20mm) protruding into the arc chamber 16, wherein the cathode is typically comprised of tungsten or other refractory material. A cathode holder 38 is positioned outside of the arc chamber 16 and supports the cathode 14 at an open end 40 of the cathode. The filament 12 (typically a twisted tungsten wire having a diameter of 0.5-3mm that forms a planar structure) is held parallel to, and in close proximity with, a planar interior surface 42 of the end cap 36 by a filament support 44. The filament 12 is typically held between 0.3-1.5mm from the planar interior surface 42 of the end cap 36 of the cathode 14 by the filament support 44.

Typically, a current of tens to a hundred amperes is passed through the filament 12, causing the filament to thermionically emit electrons. By applying a voltage (typically ranging between 300-1000V) between the filament 12 and the cathode 14, electrons emitted from the filament are accelerated towards to the cathode, thereby heating the cathode to thermionically emit electrons from a front surface 46 of cathode within the arc chamber 16, thereby ionizing the feed gas 20.

One common failure mode of the cathode 14 is from erosion, whereby the end cap 36 of the cathode 14 is typically eroded over time due to sputtering by the plasma 26. When the end cap 36 has been completely eroded, the filament 12 is exposed directly to the plasma 26, at which time the filament is quickly eroded and fails. One conventional remedial design is to increase a length of the end cap 36 when viewed perpendicular to the center axis 32 (commonly called a “thickness” of the end cap), as the time taken to erode the end cap is roughly proportional to an initial thickness of the end cap. However, the present disclosure appreciates that end cap 36 cannot be thickened without limit, as a thicker end cap will require application of more power to the planar interior surface 42 of the end cap 36 facing the filament 12 in order that the front surface 46 facing the plasma 26 reach the temperature required for thermionic emission from the cathode 14.

Too much power supplied to the planar interior surface 42 of the end cap 36 can evaporate the material (tungsten) from the planar interior surface that is subsequently deposited on the filament 12, thus decreasing the electrical resistance of the filament. Eventually, not enough power can be supplied by a fixed power supply between filament 12 and the cathode 14 to drive the cathode into thermionic emission. Typically, power for the ion source 10, including power provided to the filament 12 and the cathode 14, is supplied from a gas box (not shown) that is electrically isolated from electrical ground by a transformer, thus limiting the total power that can be supplied to the ion source. The present disclosure contemplates advantageously reducing power losses from the open end 40 and sides 48 of the cathode 14, whereby a lower power would be needed to drive the front surface of the cathode into thermionic emission, thus enabling a thicker cathode to be used without overheating the rear surface of the cathode.

Power losses from the cathode 14 are both conductive and radiative. A cathode shield 50 may be provided to surround the cathode 14, whereby the cathode shield acts to reduce radiative losses through the sides 48 of the thin-walled cylinder 34 and end cap 36 of the cathode to the sidewalls 24 of the arc chamber 16. While being a separate component from the cathode 14, the cathode shield 50 is also typically supported by the cathode holder 38 that is significantly cooler than the cathode, whereby thermal losses are present from the cathode through the thin-walled cylinder 34 due to thermal conduction to the cathode holder. The thin-walled cylinder 34 of the cathode 14, however is made as thin as practical while being robust enough to support the end cap 36 and provide gas isolation.

Further, radiative losses may be present from the sides 48 of the cathode 14, from the planar interior surface 42 of the cathode, and from the filament 12. itself, whereby the thermal radiation is lost through the open end 40 of the cathode to the cathode holder 38, the filament support 44 and/or other structures proximate to the open end that are substantially cooler than the cathode 14. Radiative losses are also present from the front surface 46 of the cathode 14, but since the front surface is open for electrons to move into the plasma 26, thermal losses from the front surface are considered acceptable.

The present disclosure contemplates advantageously reducing power losses from rear and side surfaces of an indirectly heated cathode of an ion source by providing a monolithic cathode body housing a filament within a cavity thereof, whereby a lower power would be needed to drive a plasma-facing surface of the monolithic cathode body into thermionic emission, thus enabling a longer or thicker cathode to be used without overheating a rear surface of the cathode. The disclosure further integrates one or more thermal shields into the structure of the monolithic cathode body itself, as opposed to providing shields as separate structures, as seen in conventional cathodes. The disclosure contemplates various geometries of the monolithic cathode body, whereby a method for forming and fabricating the structures of the monolithic cathode body is further provided. For example, the method may be achieved by an Additive Manufacturing (AM) process or other formation processes, whereby the resulting monolithic cathode body comprises one or more thermal shields (e.g., thermal radiation shields) that are integral to a monolithic, continuous, and unitary body.

By integrating the thermal shields into the monolithic cathode body, conductive losses from separate structures, such as cathode supports, filament supports, or other supports or holders associated therewith are minimized or eliminated, thus enabling a cathode end cap to be thicker or longer than a conventional cathode, yet be driven by approximately the same power. Further, the present disclosure contemplates the one or more thermal shields as either replacing the conventional (separate) cathode shield, or the one or more thermal shields may provide an additional thermal shielding behind the filament toward an open end of the monolithic cathode body. The present disclosure contemplates any of these aspects be practiced separately, or in combination.

The one or more thermal shields, for example, may be arranged between the filament and a cathode support structure associated with an open end of the monolithic cathode body to reduce rearward heat loss and gas conductance toward the filament. In another example, at least one thermal shield may be circumferentially positioned about the monolithic cathode body to reduce lateral radiative losses, thereby extending cathode lifetime and improving power efficiency of the ion source.

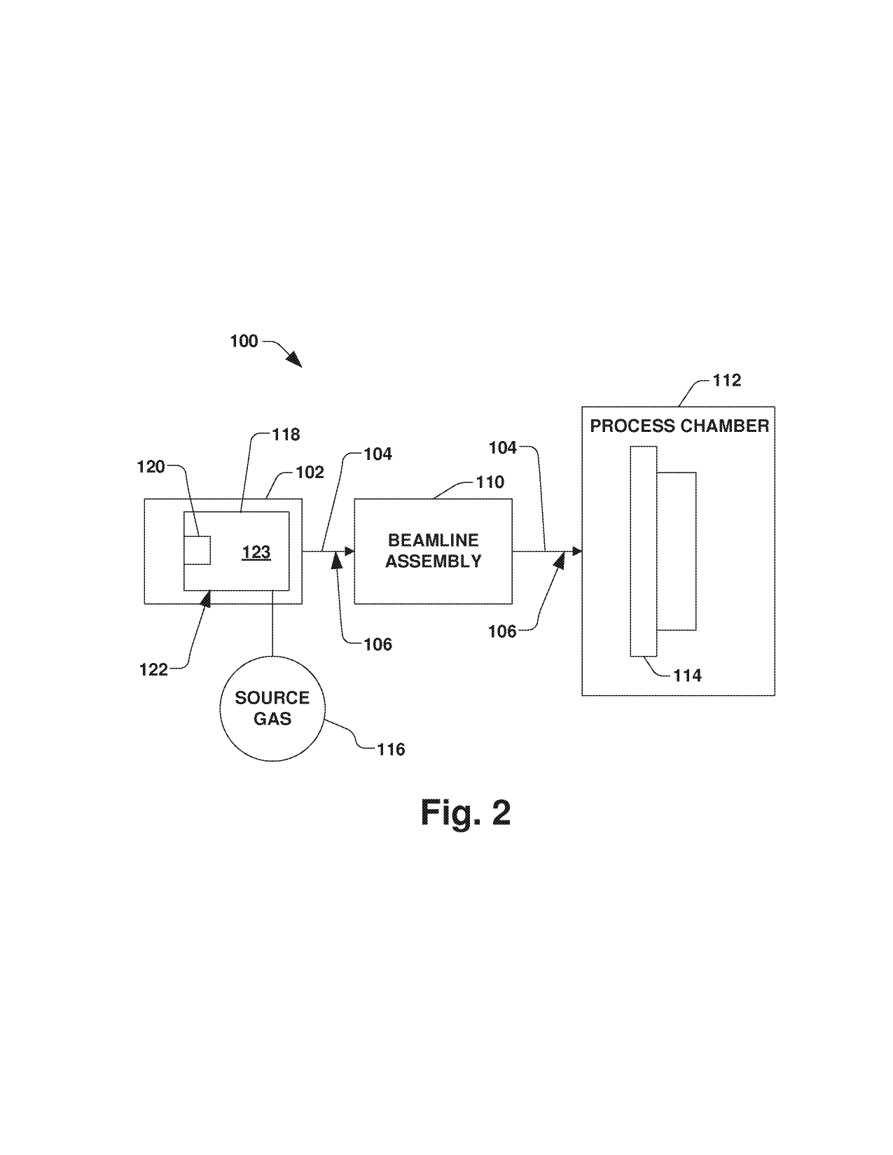

FIG. 2 illustrates a system 100 that includes an IHC ion source 102 for producing an ion beam 104 along a beam path 106. A beamline system 110 is provided downstream of the ion source 102 to receive a beam therefrom. The beamline system 110 may include (not shown) a mass analyzer, an acceleration structure, which may include, for example, one or more gaps, and an angular energy filter. The mass analyzer includes a field generating component, such as a magnet, and operates to provide a field across the beam path 106 so as to deflect ions from the ion beam 104 at varying trajectories according to mass (e.g., mass-to-charge ratio). Ions traveling through the magnetic field experience a force which directs individual ions of a desired mass along the beam path 106 and which deflects ions of undesired mass away from the beam path.

A process chamber 112 is provided in the system 100, which contains a target location that receives the ion beam 104 from the beamline system 110 and supports one or more workpieces 114 such as semiconductor wafers along the beam path 106 for implantation using the final mass analyzed ion beam. The process chamber 112 then receives the ion beam 104 which is directed toward a workpiece 114. It is appreciated that different types of process chambers 112 may be employed in the system 100. For example, a "batch" type process chamber 112 can simultaneously support multiple workpieces 114 on a rotating support structure, wherein the workpieces 114 are rotated through the path of the ion beam 104 until all the workpieces 114 are completely implanted. A "serial" type process chamber 112, on the other hand, supports a single workpiece 114 along the beam path 106 for implantation, wherein multiple workpieces 114 are implanted one at a time in serial fashion, with each workpiece being completely implanted before implantation of the next workpiece begins. The system 100 may also include a scanning apparatus (not shown) for moving the ion beam 104 with respect to the workpiece 114, or the workpiece with respect to the ion beam.

A source gas 116 (also referred to as a feed gas) containing a desired dopant element is provided to a source chamber 118 (also referred to as an arc chamber) of the ion source 102, whereby the ion source generates ions from the source gas within the source chamber, and whereby the ionized source gas is subsequently extracted from the source chamber in the form of the ion beam 104. The ionization process is effectuated by an exciter, which in various examples of the present disclosure, takes the form of an indirectly heated cathode (IHC) 120, thereby defining an IHC ion source 122.

The present disclosure appreciates that the lifetime of the IHC ion source 122 and the IHC 120 is generally determined by thermal stresses and power losses associated with operation of the IHC within the source chamber 118. In particular, radiative and conductive thermal losses from rearward and lateral surfaces of the IHC 120 increase the power required to maintain desired thermionic emission from the IHC within a plasma environment 123 of the IHC ion source 122. Over time, such elevated power levels accelerate erosion and degradation of the IHC 120, thereby reducing the effective lifetime of the IHC and requiring replacement thereof.

The present disclosure contemplates minimizing deleterious thermal losses associated with the IHC ion source 122 by reducing radiative and conductive heat transfer from regions of the IHC 120 that do not contribute to desired electron emission into the plasma environment 123. While cathode shield structures have been previously provided as separate components from conventional cathodes to reduce some radiative losses, such structures can introduce additional conductive heat paths to cooler support structures and may be limited in their effectiveness due to geometric and space constraints within the ion source.

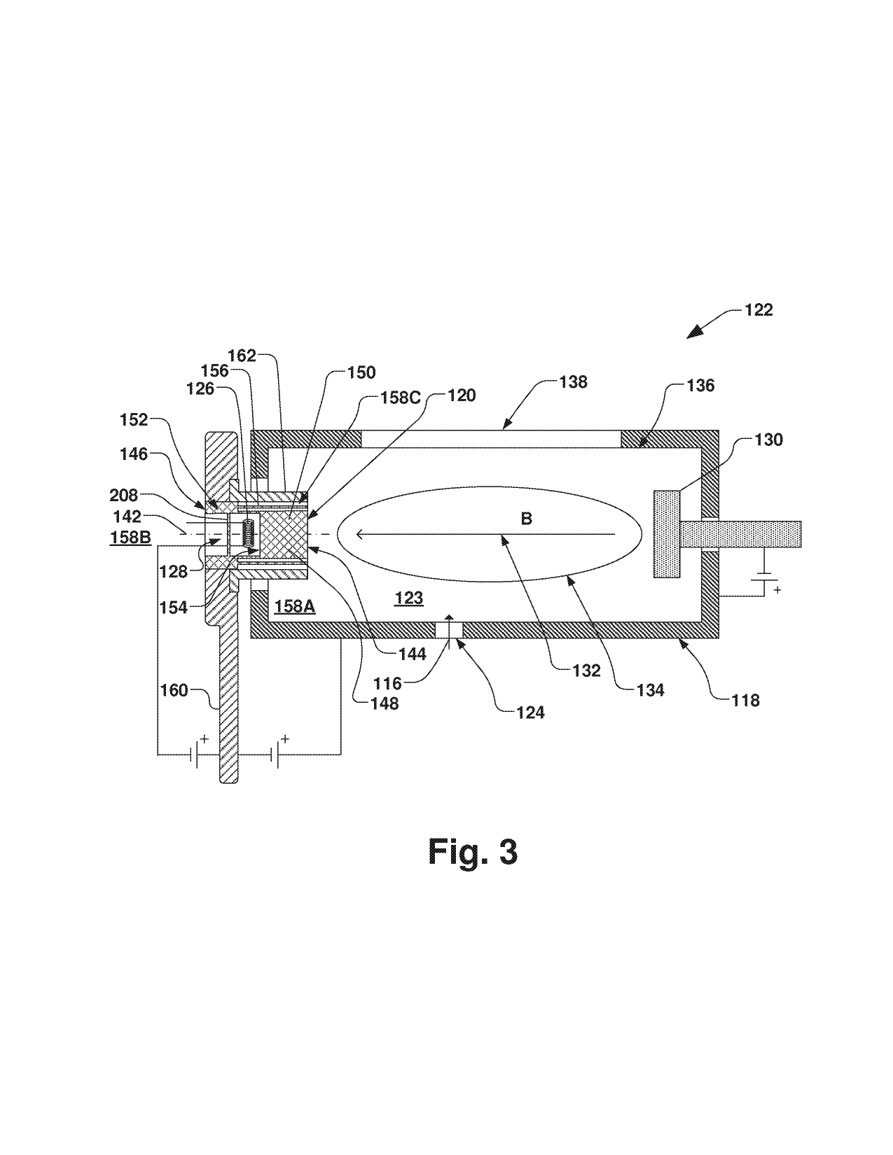

As illustrated in FIG. 3, in accordance with various aspects of the disclosure, the IHC ion source 122, for example, comprises one or more gas feed inlets 124 for feeding the source gas 116 (e.g., a feed gas) to the source chamber 118. A filament 126, for example, is positioned within a cavity 128 of the IHC 120, whereby the filament is resistively heated to temperatures high enough to emit electrons. The electrons emitted from the filament 126 are accelerated to bombard the IHC 120 which is maintained at an electrical potential that is positive with respect to the filament, whereby the IHC is consequently heated.

In the present example, a repeller 130 that is positioned generally opposite to the IHC 120 within the source chamber 118. While not shown, a source magnet can provide a magnetic field 132 along a source chamber axis generally defined between the IHC 120 and the repeller 130. During operation of the IHC ion source 122, the magnetic field 132 helps confine the electrons along field lines between the IHC 120 and the repeller 130 to define a plasma column 134, thus reducing a loss of electrons to one or more chamber walls 136 of the source chamber 118. The loss of electrons is further reduced by the repeller 130, which is typically at the potential of the IHC 120 to reflect electrons back toward the IHC. The excited electrons ionize the source gas 116 which is fed into the source chamber 118 through the one or more gas feed inlets 124, thus generating a plasma. Ions are further extracted through an aperture 138 and electrostatically accelerated to form a high energy ion beam by an electrode positioned outside the source chamber 118.

In accordance with one embodiment of the present disclosure, the IHC 120 comprises a monolithic cathode body 140 extending along an axis 142 from a first end 144 to a second end 146 of the monolithic cathode body. It is to be appreciated that the term “monolithic” is to be understood as consisting of a unitary component, thus forming an integral, continuous, and contiguous body to define the monolithic cathode body 140 as a single, unitary, unbroken piece, and may be formed from a single solid piece or fused into a single piece from a single material, such as tungsten.

The axis 142, for example, may be coaxial with the source chamber axis defined between the IHC 120 and the repeller 130. The monolithic cathode body 140, for example, comprises a solid rod 148 defining an end cap 150 of the monolithic cathode body, whereby the solid rod extends from the first end 144 toward the second end 146 of the monolithic cathode body. Further, the monolithic cathode body 140 comprises a tubular portion 152 that is contiguous with the solid rod 148, whereby the tubular portion and the solid rod define the cavity 128 in which the filament 126 is positioned. The cavity 128, for example, extends from the second end 146 toward the first end 144 of the monolithic cathode body 140, whereby the solid rod 148 generally defines a closed end wall 154 of the cavity.

Further, in accordance with the present disclosure, the monolithic cathode body 140 comprises one or more thermal shields 156 contiguous with one or more of the tubular portion 152 and the solid rod 148. The one or more thermal shields 156, for example, are configured to limit a transfer of thermal radiation from the filament 126 to one or more regions 158 external to the monolithic cathode body 140. The one or more regions 158 are illustrated in FIG. 3 as a first region 158A between the monolithic cathode body 140 and the one or more chamber walls 136, a second region 158B proximate to the second end 146, and a third region 158C external to an external circumference of the monolithic cathode body, as will be discussed further infra.

In the present example, the monolithic cathode body 140 is supported within the source chamber 118 via a cathode holder 160 (also called a cathode support), whereby the monolithic cathode body is electrically coupled to the cathode holder and electrically biased relative to the filament 126. In the present example, while not required, the IHC ion source 122 further comprises a cathode shield 162 generally surrounding the IHC 120, whereby the cathode shield may further limit thermal radiation from being transferred external to the IHC. The cathode shield 162 is separate from the monolithic cathode body 140, whereby the cathode shield is further supported by the cathode holder 160 or separately supported. In other examples, the cathode shield 162 may be replaced by the one or more thermal shields 156.

Accordingly, the present disclosure further advantageously increases a heating of the solid rod 148 by limiting the transfer of thermal radiation external to the monolithic cathode body 140 and concentrating thermal energy at the solid rod via the integration of the one or more thermal shields 156 into the monolithic cathode body, itself. By forming the one or more thermal shields 156 as part of the cathode itself, the present disclosure may limit or minimize radiative losses toward the first region 158A associated with the one or more chamber walls 136, the second region 158B associated with the second end 146 of the monolithic cathode body 140, and/or the third region 158C external to the external circumference of the monolithic cathode body, while also minimizing or avoiding conductive heat paths associated with separate shielding components or other support features implemented in an conventional ion source.

The one or more thermal shields 156, for example, enable a lower operating power to achieve a desired cathode front-surface temperature at the first end 144 and permit the use of an enlargement of the solid rod 148 (e.g., an increase in length of the end cap 150 along the axis 142) without overheating rearward surfaces proximate to the second end 146. The present disclosure thus results in an improved lifetime of the IHC 120, improved thermal efficiency of the IHC ion source 122, enhanced operational stability, and reduced incidence of cathode and filament failure, as compared to conventional systems.

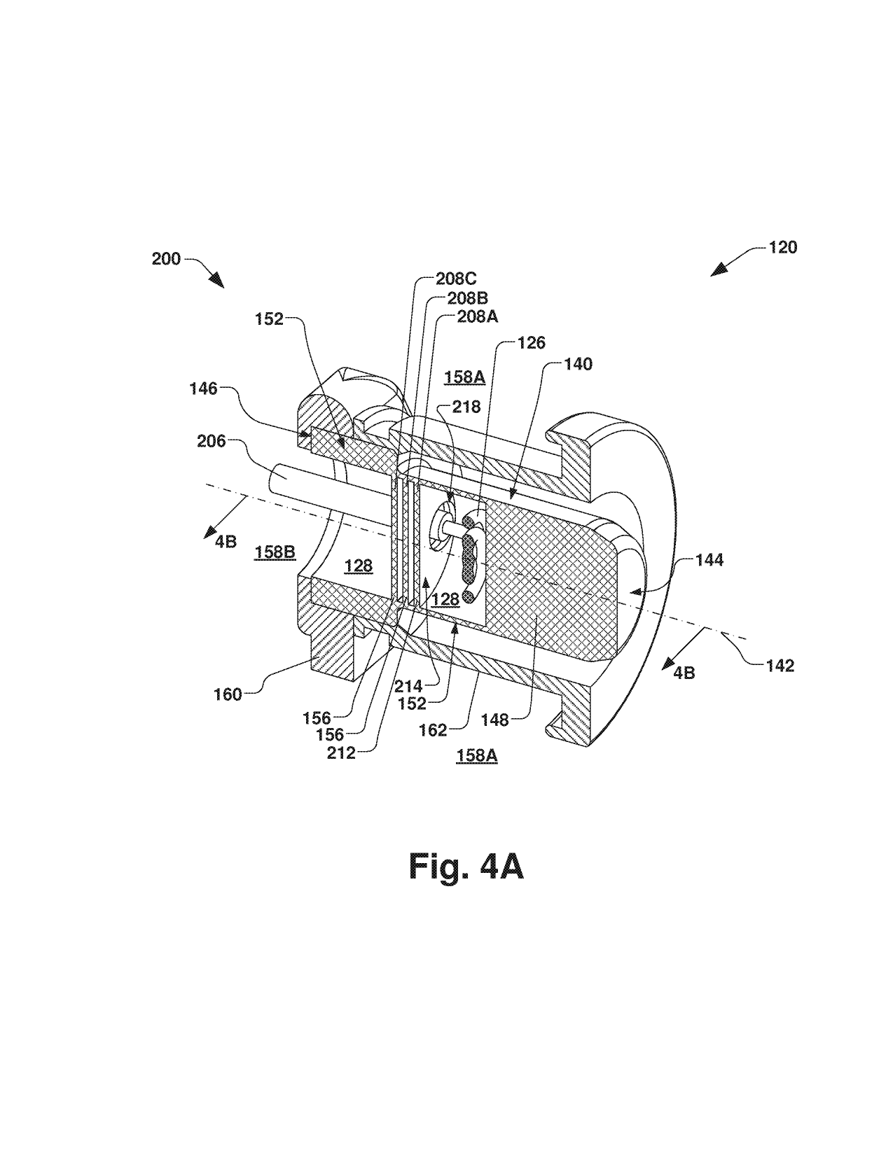

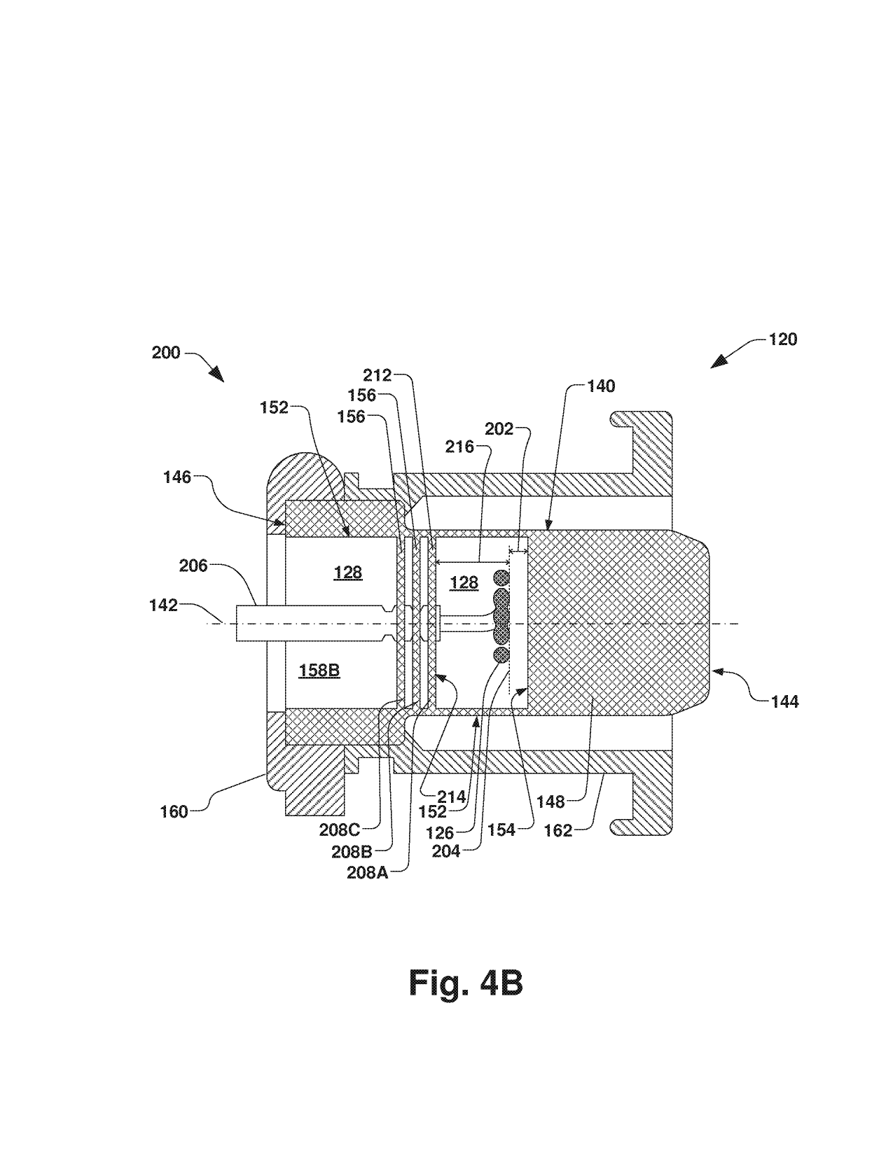

In a first example embodiment 200 of the IHC 120 illustrated in FIGS. 4A-4B, the monolithic cathode body 140 is generally cylindrical, whereby the filament 126 is configured to be axially positioned a first predetermined distance 202 from the closed end wall 154 of the cavity 128. In the present example, the filament 126 is generally planar and defines a filament plane 204, whereby the first predetermined distance 202 separates the closed end wall 154, which is also planar, from the filament plane. The filament 126, for example, is electrically coupled to one or more support leads 206, whereby the one or more support leads may be clamped by a filament clamp (not shown) to selectively position the filament at the first predetermined distance 202 from the closed end wall 154.

As illustrated in the first example embodiment 200, the one or more thermal shields 156 may comprise at least one disk 208 disposed within the cavity 128, whereby the filament 126 is disposed between the at least one disk and the closed end wall 154 of the cavity. In the present example shown in FIGS. 4A-4B a plurality of disks 208A, 208B, 208C are illustrated as being evenly spaced from one another, however other spacings, configurations, and number of disks are also contemplated. The plurality of disks 208A, 208B, 208C, for example, may be configured to provide staged radiative shielding while limiting conductive heat transfer.

In the present example, the disk 208A defines an innermost disk 212 that is closest to the closed end wall 154. The innermost disk 212, for example, defines a filament facing surface 214 when viewed along the axis 142, whereby a second predetermined distance 216 is defined between the filament facing surface and the filament plane 204, as shown in FIG. 4A. The second predetermined distance 216, for example, is greater than the first predetermined distance 202, whereby the innermost disk 212 is positioned further from the filament 126 than to the closed end wall 154. As such, electrons from the filament 126 are not substantially drawn to the innermost disk 212, but rather, are advantageously drawn toward the closed end wall 154 of the cavity 128 and the solid rod 148. The second predetermined distance 216, for example, may be at least twice the first predetermined distance 202.

Experimental results have shown that the provision of just a single disk 208 (e.g., illustrated in FIG. 3) reduced the power supplied to the filament 126 by approximately 30% to provide an equivalent emission as a cathode with no disks. Modeling of a similar structures show that the length of the solid rod 148 could be thus increased along the axis 142 from 11.74mm to 14.24mm at a constant cathode power, representing a 20% improvement in lifetime of the IHC ion source 122.

In accordance with another example, the at least one disk 208 (e.g., the plurality of disks 208A, 208B, 208C of FIG. 4A) comprises one or more apertures 218 defined therethrough, wherein the one or more support leads 206 extend through the one or more apertures, respectively. It is noted that in the present example, the IHC 120 is shown in cross-section and is generally symmetric, whereby while not shown, it is to be understood that the one or more apertures 218 comprise two apertures configured to pass two support leads 206 therethrough.

The at least one disk 208, for example, is contiguous with the tubular portion 152 of the monolithic cathode body 140, as discussed above, and may comprise one or more thin sheets of material are interposed between the planar surface of the filament 126 and the cathode holder 160 of FIG. 3 and/or filament support (not shown) in the second region 158B. Each sheet of material of the at least one disk 208, for example, is integrally connected to the tubular portion 152 of the monolithic cathode body 140 and has a minimal cross-sectional area when viewed perpendicular to the axis 142, whereby conductive losses from the sheet to the tubular portion of the monolithic cathode body is minimized. Alternatively, fewer, but thicker sheets may be integrally connected to the tubular portion 152 of the monolithic cathode body 140 at fewer connection points to provide both structural support and to minimize conductive losses, whereby their effectiveness as radiation shields is not affected. The at least one disk 208, for example, may be planar or non-planar. For example, while not shown, the at least one disk 208 may a body having convolutions defined therein, whereby the convolutions may advantageously limit heat transfer through the at least one disk. Alternatively, the at least one disk 208 may be convex, concave, or otherwise angled from the the cavity and a center of the at least one disk when viewed perpendicular to the axis 142 to further limit heat transfer to the second region 158B. As such, the present disclosure contemplates the at least one disk 208 taking any shape, whereby radiation, conduction, and/or convection may be advantageously minimized.

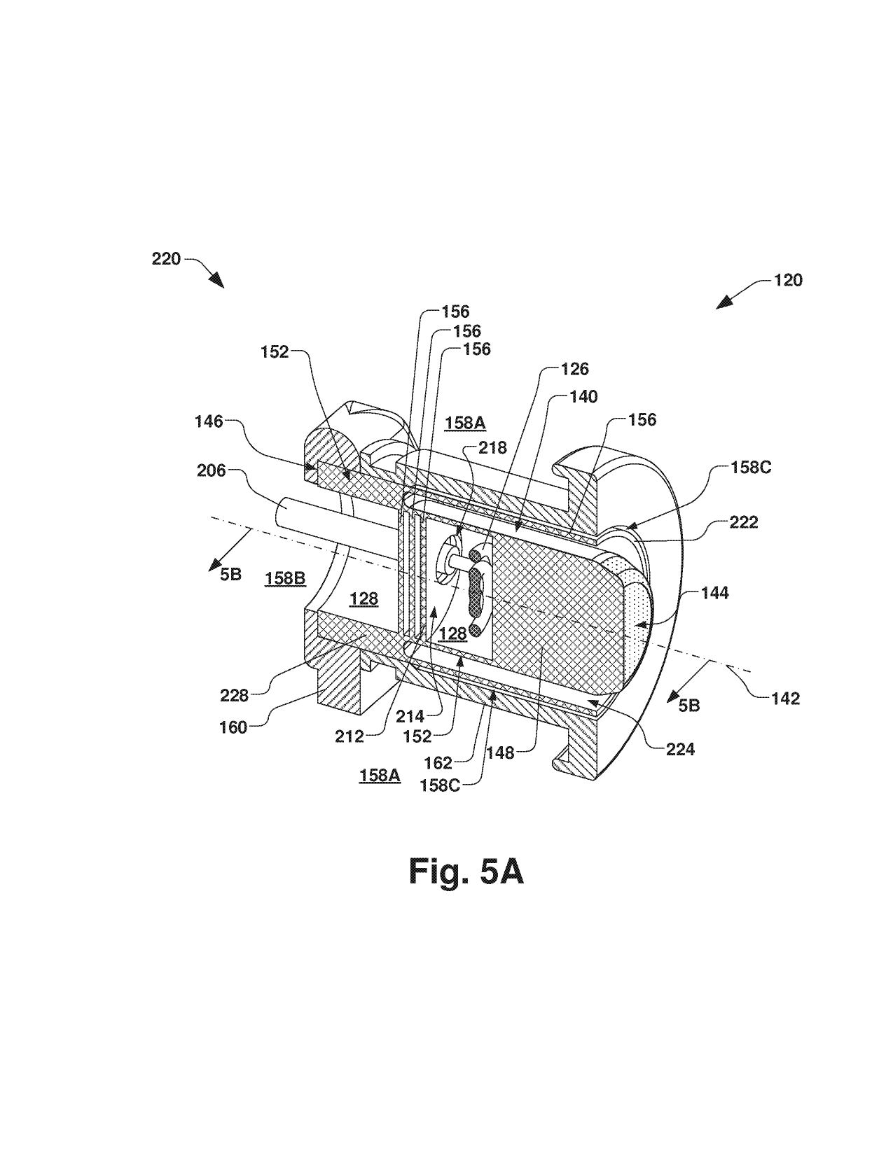

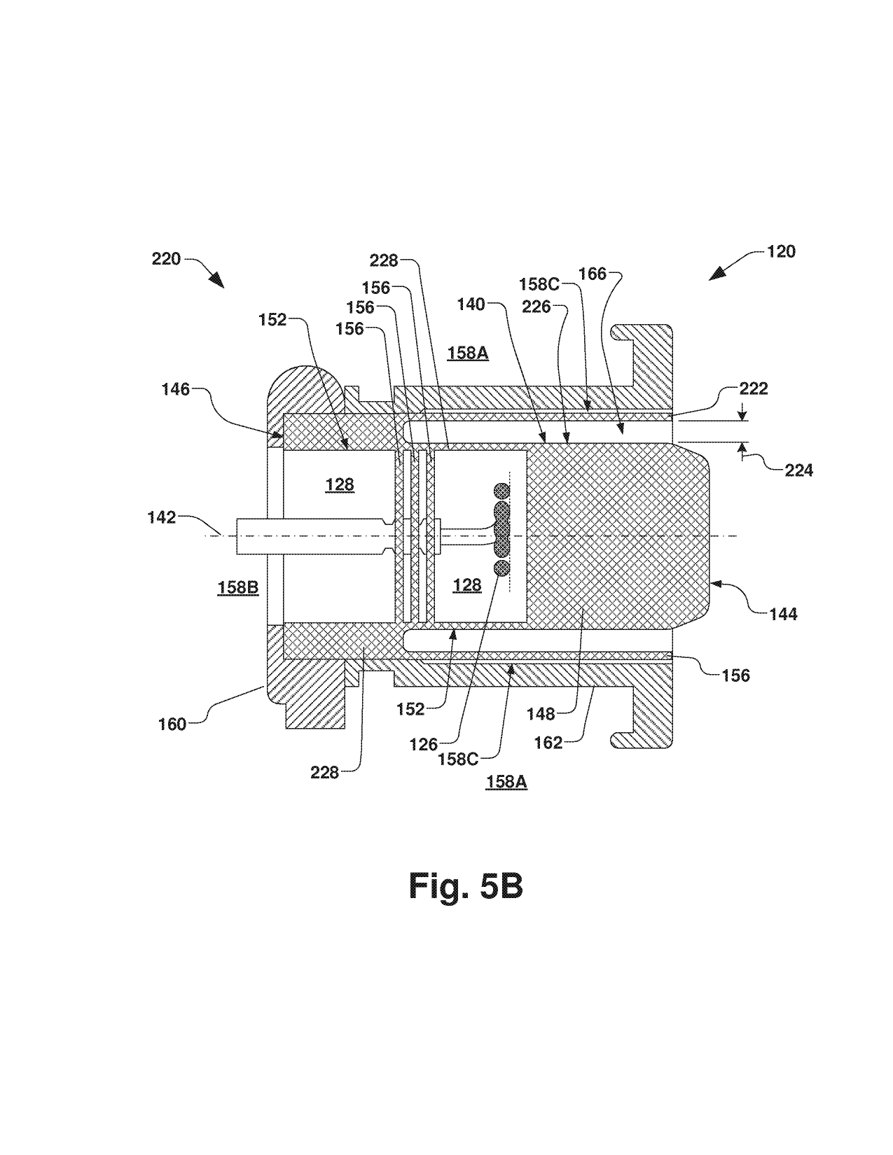

In a second example embodiment 220 of the IHC 120, FIGS. 5A-5B illustrate the monolithic cathode body 140 as being generally cylindrical in a manner similar to that shown in FIGS. 4A-4B, whereby the three disks 208A, 208B, 208C are similarly illustrated for limiting the transfer thermal radiation from the filament 126 to the second region 158B. However, the one or more thermal shields 156 shown in FIGS. 5A-5B, for example, further comprise at least one annular shield 222 axially encircling, and contiguous with, at least the tubular portion 152 of the monolithic cathode body 140. The at least one annular shield 222, for example, is spaced an annular shield distance 224 from an external circumference 226 of the tubular portion 152 and the solid rod 148, as illustrated in FIG. 5B. The at least one annular shield 222, for example, reduces radiative losses through the external circumference 226 of the tubular portion 152 and the solid rod 148 to the third region 158C. For example, the at least one annular shield 222 further limits radiative heat transfer radially outward toward the cathode shield 162, thus further advantageously permitting lower power and/or a lengthening of the solid rod 148, as discussed above.

It is noted that, while not shown, the one or more thermal shields 156 shown in FIGS. 5A-5B may be provided in the monolithic cathode body 140 without providing the at least one disk 208 disposed within the cavity 128, and such an embodiment is further contemplated.

The at least one annular shield 222 illustrated in FIGS. 5A-5B, for example, is integrally connected to the tubular portion 152 of the monolithic cathode body 140 and has a minimal cross-sectional area when viewed perpendicular to the axis 142, whereby conductive losses from the sheet to the tubular portion of the monolithic cathode body is minimized. In contrast to conventional cathode shield designs, the present disclosure makes possible the provision of multiple thermal shields 156 in a confined area, thereby improving the efficiency of the thermal shields. Additionally, as the thermal shields 156 are integrally connected to a thin sidewall 228 of the tubular portion 152 of the monolithic cathode body 140, and, for example, are only connected to the cooler cathode holder 160 through the thin sidewall of the monolithic cathode body, itself, conductive losses are further reduced. Still further, the present disclosure reduces gas conductance between the plasma environment 123 of the IHC ion source 122 and the filament 126 of FIG. 3, for example, thus reducing the effects of chemical reactions between the hot filament and the various gases used in the IHC ion source that leak into the second end 146 (e.g., the open end) of the IHC cathode 120.

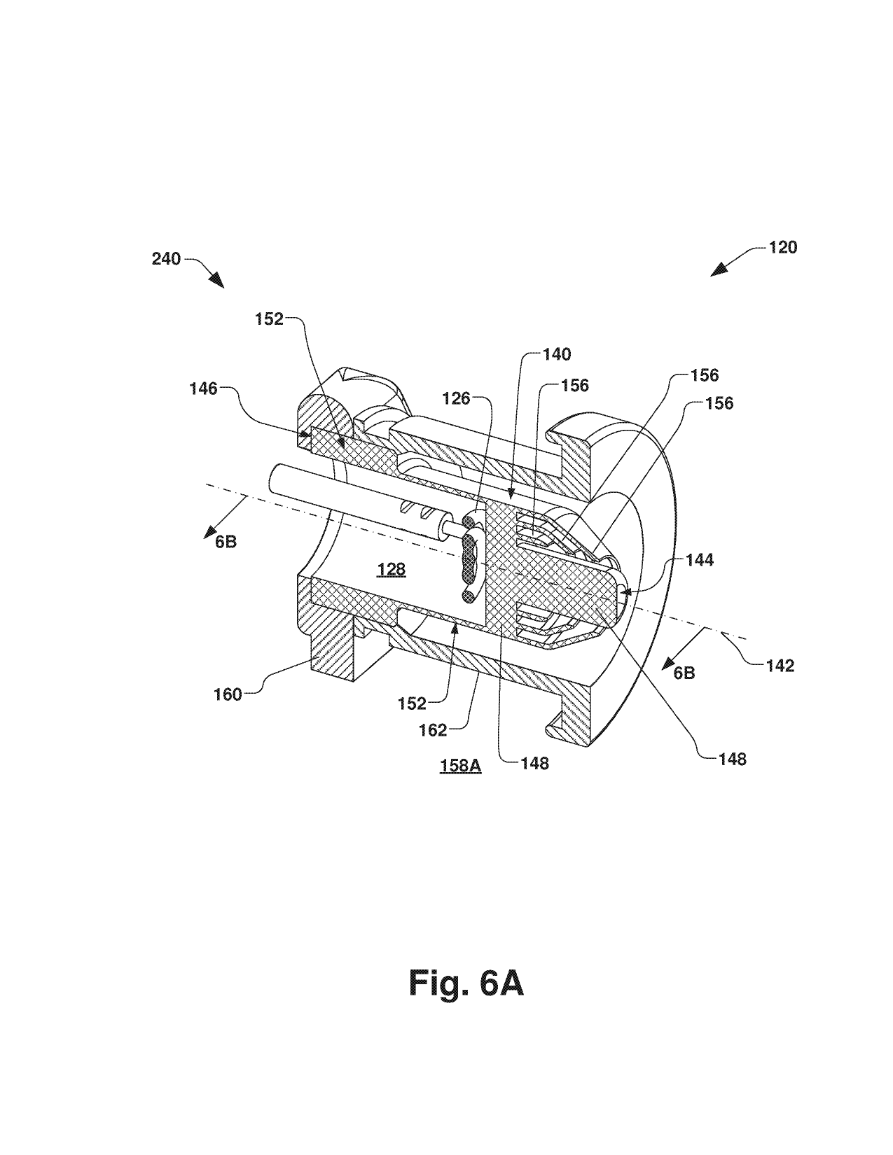

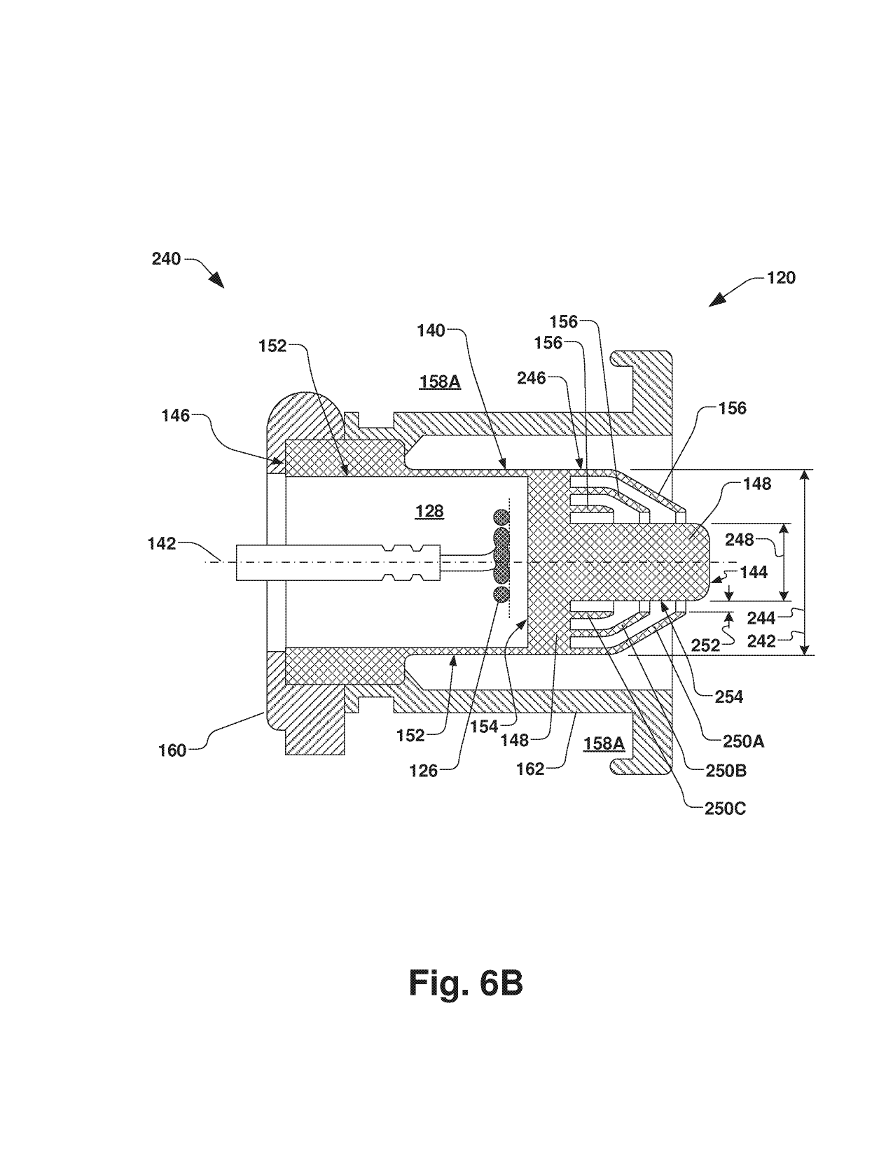

In a third example embodiment 240 of the IHC 120 shown in FIGS. 6A-6B, the tubular portion 152, for example, defines a tubular portion outer diameter 242 wherein the solid rod 148 defines a solid rod outer diameter 244, as shown in FIG. 6B. The solid rod outer diameter 244, for example, decreases from the tubular portion outer diameter 242 in a stepped region 246 of the solid rod 148 to define a stepped diameter 248 of the solid rod. In accordance with the present example, the one or more thermal shields 156 further comprise one or more stepped shields 250 (e.g., illustrated as first stepped shield 250A, second stepped shield 250B, and third stepped shield 250C) axially encircling the solid rod 148 in the stepped region 246. The one or more stepped shields 250 are contiguous with the solid rod 148 proximate to the closed end wall 154, wherein the one or more stepped shields are spaced a respective stepped shield distance 252 from a stepped region circumference 254 of the stepped region 246 of the solid rod 148.

Further, in accordance with another example, one or more of the stepped shields 250 defines a respective tapered shield, such as the first stepped shield 250A and second stepped shield 250B, and wherein a diameter of the respective tapered shield respectively increases from the first end 144 toward the second end 146 of the monolithic cathode body 140.

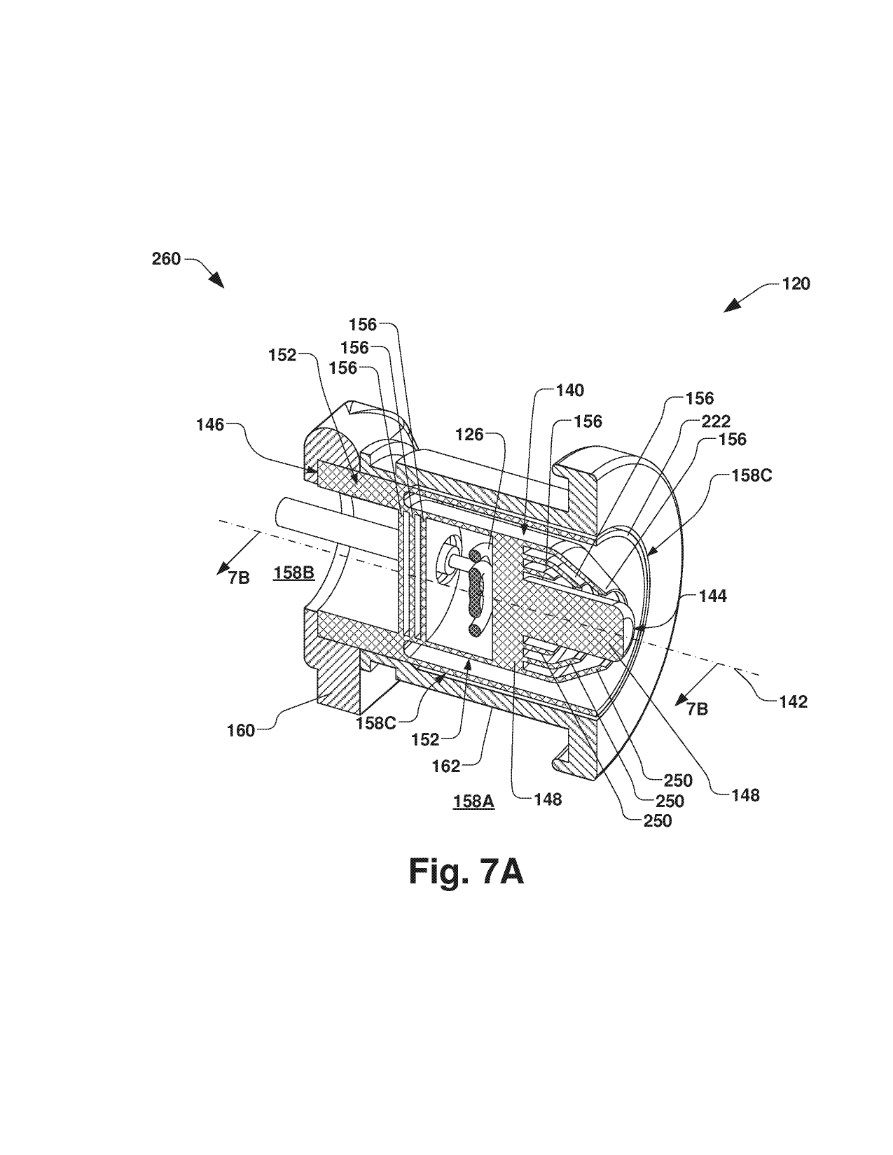

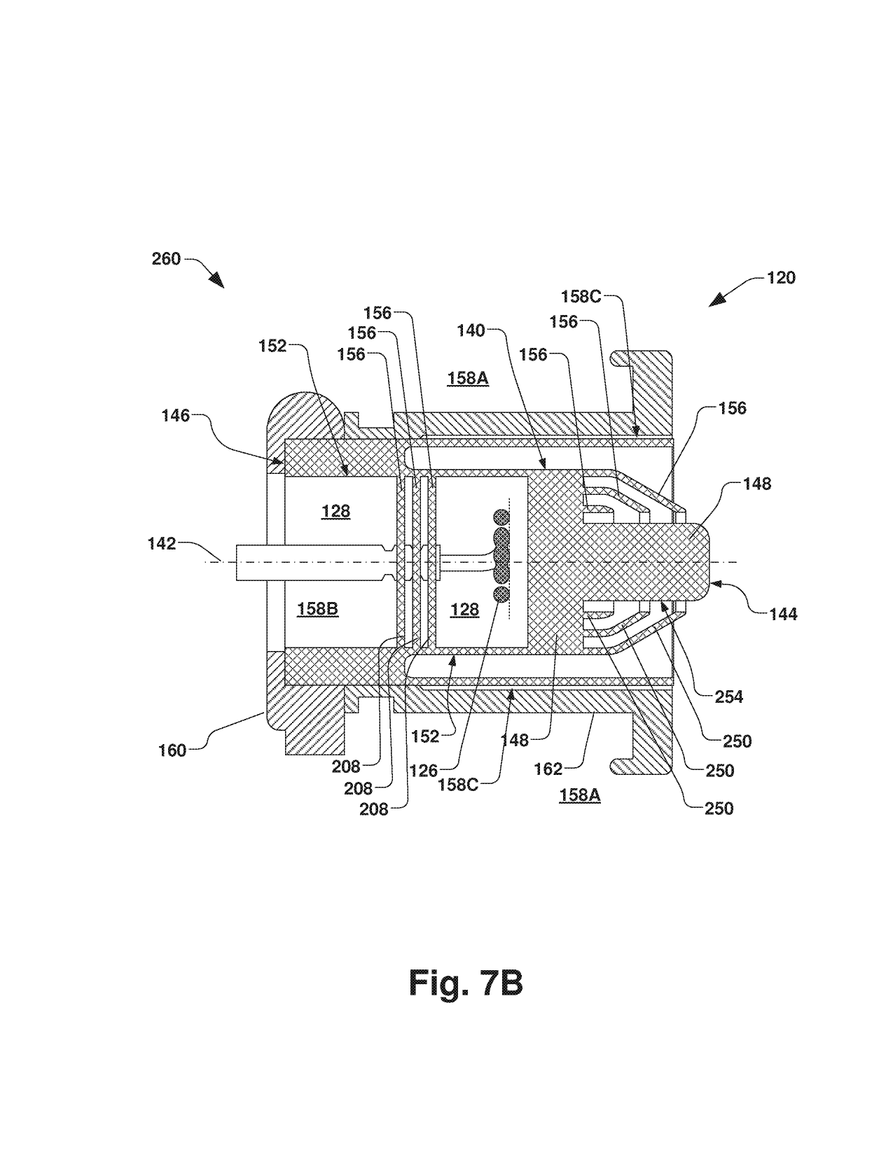

Various combinations of features of FIGS. 4A-4B, 5A-5B, and 6A-6B are further contemplated. In fourth example embodiment 260 of the IHC 120 is illustrated in the example shown in FIGS. 7A-7B, whereby the one or more stepped shields are provided, as well as the at least one annular shield 222, and the one or more disks 208 in the IHC, thus providing a combination of the various advantages discussed above in the fourth example embodiment.

It is further noted that other combinations of the first, second, third, and fourth embodiments discussed above may be provided, and are contemplated as falling within the scope of the present disclosure. The present disclosure contemplates various approaches to fabricating the IHC 120, whereby the filament 126 and the monolithic cathode body 140 are fabricated as a single assembly. For example, the filament plane 204 of the filament 126 may be held captive between the closed end wall 154 of the cavity 128, whereby the filament is positioned between the at least one disk 208 and the closed end wall of the cavity concurrent with the fabrication of the monolithic cathode body 140.

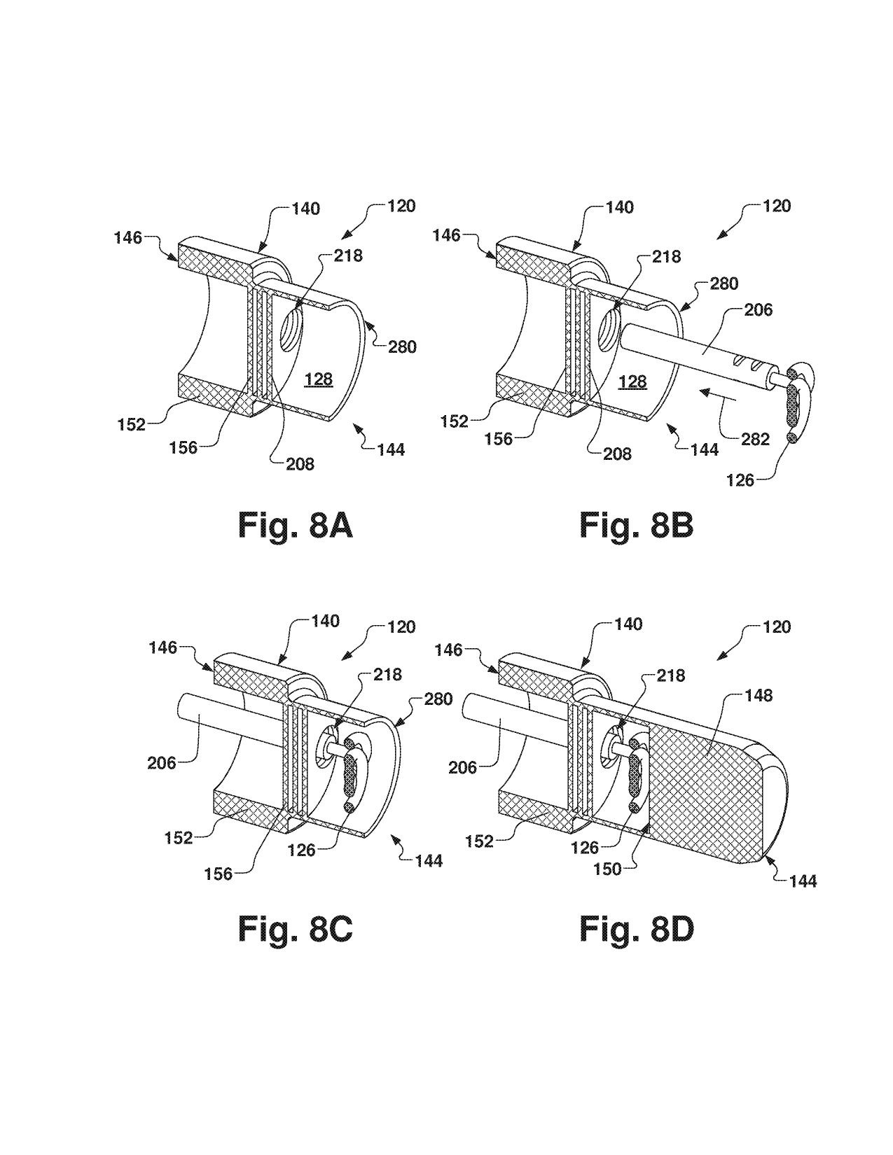

FIGS. 8A-8D illustrate an example series of cross-sectional perspective views of a method for forming the IHC 120. In one example, the present disclosure contemplates the fabrication of the IHC 120 being performed using an Additive Manufacturing (AM) approach. The formation and growth of the monolithic cathode body 140 of the IHC 120, for example, may preferably proceed from the second end 146 (e.g., the open end) of the monolithic cathode body by fabricating the tubular portion 152 and at least one disk 208 up to a point 280 where the interior surface of the end cap 150 starts in FIG. 8A. At this point, the filament 126 may be positioned (illustrated as arrow 282) in the cavity 128 in FIG. 8B such that the one or more support leads 206 may be passed through the one or more apertures 218 held in place by the tubular portion 152 as shown in FIG. 8C until AM growth can proceed to fabricate the end cap 150 (e.g., the solid rod 148) of the monolithic cathode body 140 shown in FIG. 8D. While the progression from the second end 146 toward the first end 144 is described above, the present disclosure also contemplates growth via AM fabrication techniques starting from the first end and progressing to the second end, or any other AM fabrication technique is accordingly contemplated.

Alternatively, other manufacturing techniques may be utilized to form the IHC 120 having the monolithic cathode body 140, such as e-beam welding, or other manufacturing techniques known to one skilled in the art. Further, the present disclosure contemplates any number of variations on the design of the monolithic cathode body 140, both in terms of number of thermal shields 156 and geometries of said thermal shields, whereby the thermal shields are an integral part of the monolithic cathode body. For example, the one or more thermal shields 156 may be fabricated separately from the tubular portion 152 and solid rod 148, and subsequently attached to form the monolithic cathode body 140. Modeling has shown that separating the cathode shield 162 from the monolithic cathode body 140, in combination with the one or more thermal shields 156 may provide excellent results.

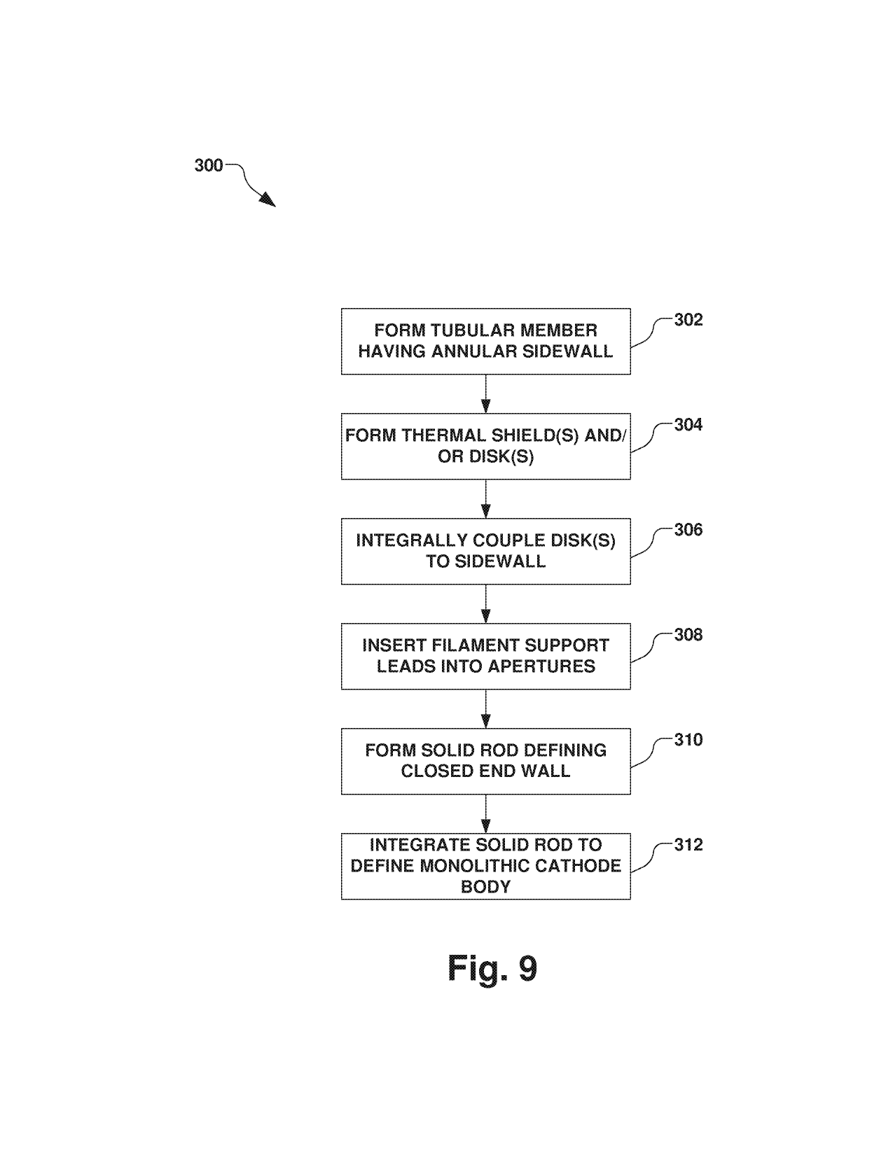

FIG. 9 illustrates an exemplary method 300 for forming an indirectly heated cathode having integrated thermal shields, whereby a monolithic cathode body is formed of a monolithic, continuous, contiguous, and unitary material, whereby a filament may be disposed within a cavity of the monolithic cathode body. It should be noted that while exemplary methods are illustrated and described herein as a series of acts or events, it will be appreciated that the present invention is not limited by the illustrated ordering of such acts or events, as some steps may occur in different orders and/or concurrently with other steps apart from that shown and described herein, in accordance with the invention. In addition, not all illustrated steps may be required to implement a methodology in accordance with the present invention. Moreover, it will be appreciated that the methods may be implemented in association with the systems illustrated and described herein as well as in association with other systems not illustrated.

Accordingly, the method 300 illustrated in FIG. 9 is just one example for forming an indirectly heated cathode, following the illustrations provided in FIGS. 8A-8D. For example, a tubular member having an annular sidewall defining an open end of a monolithic cathode body is formed in act 302 of FIG. 9. At least one disk is formed in act 304, wherein the at least one disk comprises one or more apertures defined therethrough. The at least one disk is integrally coupled to an internal surface of the annular sidewall in act 306, and one or more filament support leads having a filament coupled thereto are inserted through the one or more apertures in act 308. A solid rod is further formed in act 310. In act 312, the solid rod is integrally coupled to the tubular portion to define a closed end wall of a cavity that is defined by the annular sidewall, the closed end wall of the solid rod, and the open end of the tubular member. The tubular member, the at least one disk, and the solid rod define the monolithic cathode body, whereby the filament is positioned between the at least one disk and the closed end wall of the solid rod within the cavity to define the indirectly heated cathode, and whereby the one or more support leads extend out of the cavity from the open end of the monolithic cathode body. The present disclosure contemplates forming the tubular member, the at least one disk, and the solid rod of acts 302, 304, and 310 being performed via an additive manufacturing process, whereby the monolithic cathode body is formed of a continuous material. Alternatively, other manufacturing processes may be performed, such as e-beam welding, molding, or other processing.

Although the invention has been shown and described with respect to a certain embodiment or embodiments, it should be noted that the above-described embodiments serve only as examples for implementations of some embodiments of the present invention, and the application of the present invention is not restricted to these embodiments. In particular regard to the various functions performed by the above described components (assemblies, devices, circuits, etc.), the terms (including a reference to a “means”) used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more other features of the other embodiments as may be desired and advantageous for any given or particular application. Accordingly, the present invention is not to be limited to the above-described embodiments, but is intended to be limited only by the appended claims and equivalents thereof.

1. An indirectly heated cathode for an ion source, the indirectly heated cathode comprising:
a filament; and
a monolithic cathode body extending along an axis from a first end to a second end thereof, the monolithic cathode body comprising:
a solid rod defining an end cap and extending from the first end toward the second end;
a tubular portion, wherein the tubular portion is contiguous with the solid rod and defines a cavity extending from the second end toward the first end to a closed end wall of the cavity, and wherein the filament is positioned within the cavity; and
one or more thermal shields, wherein the one or more thermal shields are contiguous with one or more of the tubular portion and the solid rod, and wherein the one or more thermal shields are configured to limit a transfer of thermal radiation from the filament to one or more regions external to the monolithic cathode body.

2. The indirectly heated cathode of claim 1, wherein the one or more thermal shields comprise at least one disk disposed within the cavity, wherein the filament is disposed between the at least one disk and the closed end wall of the cavity, and wherein the filament is positioned at a first predetermined distance from the closed end wall and at a second predetermined distance from the at least one disk, wherein the second predetermined distance is greater than the first predetermined distance.

3. The indirectly heated cathode of claim 2, wherein the at least one disk comprises a plurality of disks axially spaced along the axis and having a predetermined spacing therebetween, wherein the filament is positioned at the second predetermined distance from an innermost disk of the plurality of disks.

4. The indirectly heated cathode of claim 2, wherein the filament comprises one or more support leads electrically coupled to the filament, and wherein the at least one disk comprises one or more apertures, wherein the one or more support leads extend through the one or more apertures, respectively.

5. The indirectly heated cathode of claim 2, wherein the one or more thermal shields further comprise an annular shield axially encircling and contiguous with at least the tubular portion of the monolithic cathode body, wherein the annular shield is spaced an annular shield distance from an external circumference of the tubular portion.

6. The indirectly heated cathode of claim 5, wherein the tubular portion defines a tubular portion outer diameter, and wherein the solid rod defines a solid rod outer diameter, wherein the solid rod outer diameter decreases from the tubular portion outer diameter in a stepped region of the solid rod.

7. The indirectly heated cathode of claim 6, wherein the one or more thermal shields further comprise one or more stepped shields axially encircling the solid rod in the stepped region thereof and contiguous with the solid rod proximate to the closed end wall, wherein the one or more stepped shields are spaced a respective stepped shield distance from a stepped region circumference of the stepped region of the solid rod.

8. The indirectly heated cathode of claim 7, wherein each of the one or more stepped shields define a respective stepped shield outer diameter, and wherein at least one stepped shield diameter respectively increases from the first end toward the second end.

9. The indirectly heated cathode of claim 1, wherein the one or more thermal shields comprise an annular shield axially encircling and contiguous with at least the tubular portion of the monolithic cathode body, wherein the annular shield is spaced an annular shield distance from an external circumference of the tubular portion and the solid rod.

10. The indirectly heated cathode of claim 1, wherein the tubular portion defines a tubular portion outer diameter, and wherein the solid rod defines a solid rod outer diameter, wherein the solid rod outer diameter decreases from the tubular portion outer diameter in a stepped region of the solid rod.

11. The indirectly heated cathode of claim 10, wherein the one or more thermal shields further comprise one or more stepped shields axially encircling the solid rod in the stepped region thereof and contiguous with the solid rod proximate to the closed end wall, wherein the one or more stepped shields are spaced a respective stepped shield distance from a stepped region circumference of the stepped region of the solid rod.

12. The indirectly heated cathode of claim 10, wherein at least one of the one or more stepped shields defines a respective tapered shield outer diameter, and wherein at least one radial tapered diameter respectively increases from the first end toward the second end.

13. An indirectly heated cathode for an ion source, the indirectly heated cathode comprising:
a filament defining a filament plane having an axis perpendicular thereto; and
a monolithic cathode body extending from a closed end to an open end thereof along the axis, the monolithic cathode body comprising:
a solid rod extending from the closed end toward the open end;
a tubular portion defining a cavity extending from the open end toward the solid rod, wherein the tubular portion is continuous with the solid rod, and wherein the solid rod defines a closed end wall of the cavity, wherein the filament plane of the filament is spaced a first predetermined distance from the closed end wall; and
one or more thermal shields configured to limit a transfer of thermal radiation from the filament to one or more regions external to the monolithic cathode body, wherein the one or more thermal shields comprise at least one disk disposed within the cavity, wherein the filament is disposed between the at least one disk and the closed end wall, and wherein the at least one disk is axially spaced a second predetermined distance from the filament plane of the filament, wherein the second predetermined distance is greater than the first predetermined distance.

14. The indirectly heated cathode of claim 13, wherein the second predetermined distance is greater than approximately twice the first predetermined distance.

15. The indirectly heated cathode of claim 13, wherein the at least one disk comprises a plurality of disks axially spaced along the axis and having a predetermined spacing therebetween, wherein the filament is positioned at the second predetermined distance from an innermost disk of the plurality of disks.

16. The indirectly heated cathode of claim 13, wherein the at least one disk comprises a body having one or more convolutions or angled surfaces defined therein.

17. The indirectly heated cathode of claim 13, wherein the tubular portion comprises a thin sidewall, wherein the at least one disk is integrally connected to the thin sidewall, and wherein the thin sidewall is configured to be coupled to a cathode holder.

18. The indirectly heated cathode of claim 13, wherein the indirectly heated cathode further comprises a cathode shield, wherein the one or more thermal shields comprise an annular shield axially encircling and contiguous with at least the tubular portion and spaced from an external circumferential surface of the monolithic cathode body, wherein the one or more thermal shields further comprise one or more stepped shields axially encircling the solid rod in a stepped region thereof, and wherein the cathode shield axially encircles the annular shield and the one or more stepped shields.

19. A method for forming an indirectly heated cathode, the method comprising:
forming a tubular member, wherein the tubular member comprises an annular sidewall defining an open end of a monolithic cathode body;
forming at least one disk, wherein the at least one disk comprises one or more apertures defined therethrough;
integrally coupling the at least one disk to an internal surface of the annular sidewall;
inserting one or more filament support leads through the one or more apertures, whereby a filament is coupled to the filament support leads;
forming a solid rod having a closed end wall; and
integrally coupling the closed end wall to the tubular portion to define a cavity between within the annular sidewall, the closed end wall of the solid rod, and the open end of the tubular member, whereby the tubular member, the at least one disk, and the solid rod define the monolithic cathode body, and wherein the filament is positioned between the at least one disk and the closed end wall of the solid rod within the cavity, whereby the filament support leads extend out of the cavity from the open end of the monolithic cathode body.

20. The method of claim 19, wherein forming the tubular member, the at least one disk, and the solid rod comprises performing an additive manufacturing process, whereby the monolithic cathode body is formed of a continuous material.
